(19) United States
(12) Patent Application Publication
(10) Pub. No.: US 2002/0124661 A1
(43) Pub. Date: Sep. 12, 2002

(54) APPARATUS FOR MEASURING FLOWS

(76) Inventor: GEORG F. WAGNER, BERCHTESGADEN (DE)

Correspondence Address: DAVID G BOUTELL, FLYNN THIEL BOUTELL & TANIS P C, 2026 RAMBLING ROAD, KALAMAZOO, MI, 490081699

(21) Appl. No.: 09/469,827

(22) Filed: Dec. 22, 1999

(30) Foreign Application Priority Data
Mar. 2, 1998 (DE) 198 08 701.2

(51) Int. Cl. G01F 1/32

(52) U.S. Cl. 73/861.23

(57) ABSTRACT

A flow measuring apparatus has a meter pipe through which the medium being metered flows, at least two ultrasonic transducers being disposed on said pipe for transmitting and receiving a beam running obliquely to the longitudinal axis of the meter pipe. The pipe wall is provided with recesses the beam to pass through from the transmitting transducer into the medium and from the medium to the receiving transducer. Sound-conducting bodies are disposed between the transducers and the medium, the beam passing perpendicularly through the boundary surfaces of said bodies with the medium and said bodies having an acoustic impedance no more than fifteen times the acoustic impedance of the medium.

This invention relates to a flow measuring apparatus according to the preamble of claim 1.

Such an apparatus is known e.g. from DE 40 10 148 A1. It measures sound propagation. That is, the transmitting transducer is aligned directly or at a certain angle three-dimensionally in the flow direction, while the receiving transducer is aligned contrary to the flow direction and disposed at a distance from the transmitting transducer such that ultrasound is either directed onto the opposite transducer directly or reflected on the inside wall of the meter pipe at least once (i.e. in a V shape), twice (in a W shape) or even more frequently. Also, a spiral-shaped measuring path is known with sound passing into and out of the medium perpendicular to the longitudinal axis of the meter pipe and skew reflecting surfaces provided in the pipe (DE 43 36 370 C1).

In known apparatuses high energy losses occur through reflections when sound passes from the transmitting transducer into the medium and out of the medium into the receiving transducer, so that the useful signal becomes a thousand and more times smaller until it approaches electronic noise and is lost. This makes it difficult or impossible to measure for example the flow of more highly elastoviscous liquids or ones containing gas bubbles or particles, etc. At present this means that the limits of noncontacting ultrasonic measuring technology for gases and liquids are hitherto reached relatively quickly.

Besides propagation measurement, one can measure flow by the ultrasonic Doppler principle, a transmitting transducer and receiving transducer being disposed in the meter pipe in the same cross-sectional area and aligned jointly into or against the flow, or one can combine ultrasonic Doppler and propagation measurement, as described in DE 42 32 526 C2. With the combined Doppler measuring method one can determine not only flow velocity but also gas bubbles and particles contactlessly and in real time. There is a great need e.g. in the coating industry, for example for films and lacquers, to locate ever smaller gas or solid reflectors. The smaller the reflectors are, the higher the irradiated energy or the smaller the reflection losses must be kept. The known apparatus can already locate reflectors with a size of <<1 micron; it is also suitable for opaque media.

The problem of the invention is to provide a high-power ultrasonic flow measuring apparatus with stable measurement.

This is obtained according to the invention by the apparatus characterized in claim 1. The subclaims render advantageous developments of the invention.

According to the invention a sound-conducting body is disposed between each transducer and the liquid or other medium flowing through the pipe, the ultrasonic beam passing perpendicularly through the boundary surface of said body with the medium. This perpendicular passage makes the system independent of the refractive indexes of the liquid or other medium flowing through the pipe according to Snell's law, also of temperature.

This results in a system with stable measurement. The sound-conducting body seals the transducers from the medium. Thus, the sound-conducting body at the same time prevents electric disturbances of the transducers when electroconductive media are involved.

The invention is based on the following considerations. Energy losses always occur when two media with unequal elastic properties meet. Soundwaves are either reflected on boundary surfaces upon perpendicular incidence or diffracted and reflected upon oblique incidence, whereby a “change of mode” from transversal to longitudinal or vice versa can simultaneously take place. Every change of physical state of a wave costs energy.

The ratio between sound pressure of the reflected wave pr and pressure of the incident wave pe is designated reflection factor R.

$$\frac{pr}{pe} = R ( R \leq 1 )$$

The ratio of transmitted wave pd to incident wave pe is designated transmission factor D.

$$\frac{pd}{pe} = D$$

Variables R and D depend crucially on acoustic resistances or acoustic impedance: Z₁=ρ₁·c₁ and Z₂=ρ₂·c₂. Thus Z₁ equals 46 for refined steel and Z₂ 1.5 for water.

For energy losses one calculates relative quantities.

The amount of reflected sound pressure is thus

$$20 lg ( pr / pe ) = 20 lg \vert R \vert = \\ = 20 lg \vert \frac{1.5 - 46}{1.5 + 46} \vert = - 0.5 dB$$

The amount of reflected amplitude is thus only 0.5 dB (<5%) below the amount of incident amplitude, so that almost ideal reflection is present.

In contrast, the transmitted wave has a sound pressure in water which is about 24 dB below the sound pressure of the incident wave in refined steel.

$$20 lg ( pd / pe ) = 20 lg \vert D \vert = 20 lg \vert \frac{2 \cdot 1.5}{1.5 + 46} \vert = - 24 dB$$

The relative energy balance worsens increasingly when one considers chemicotechnical liquids such as solvent mixtures, which have the following typical values: c=1200 m/s, ρ=0.8 g/cm³ and thus Z≈1 MPa/m.

When soundwaves hit oblique boundary surfaces, further effects occur by reason of Snell's law:

$$\frac{sin α}{sin β} = \frac{{c}_{1}}{{c}_{2}}$$

α=angle of incidence, β=refraction angle, c₁ and c₂=speed of sound in 1st and 2nd media) as well as mode transformation effects, which are temperature-dependent in accordance with the impact angle because the speed of sound is temperature-dependent.

It is especially important for locating reflectors according to the Doppler principle, however, that with Snell's law one can only determine the direction of propagation of the refracted soundwave, not its amplitude. Furthermore, linear polarization always occurs. Amplitude is important for determining particle size. Locating very small reflectors in a medium (with no ΔZ) is thus effective and reliable when a sound-conducting body with a corresponding constructional design permits sound pressure to be passed into the medium to be determined, and received therefrom, directionally without “scattering”. For the propagation method, as for the related “sing around” principle, it becomes possible to meter liquids or media which could hitherto not be metered. For example media having attenuations of more than 10 dB/cm at a frequency of 1 MHz were hitherto inaccessible both to determination of flow velocity and to particle detection.

In contrast, magnetic induction flowmeters are able to measure flow velocity (albeit with electrodes, not contactlessly), but only for electroconductive fluids and not particles. The inventive apparatus, however, is also suitable for determining nonconductive media, its application being extended—in contrast to conventional ultrasonic flowmeters—to new, hitherto inaccessible media, in particular compressible liquids, oils, highly saturated suspensions and dispersions, adhesives with degassing effects, such as anaerobic adhesives and the like.

As described above, it is crucial that the emitted physical peculiarity of the soundwave hits the receiver without distortion and as intensively as possible. Then and only then will the abovementioned advantages occur.

In a first version the sound-conducting body has two plane-parallel surfaces. This permits only the longitudinal soundwave to be passed into the fluid. Fluids can only transfer such longitudinal waves. Thus, this wave can also be received in the same mode. This is the optimum mode with respect to energy transfer and losses.

The sound-conducting body in the second version, i.e. with stepped sound transmission surfaces according to claim 4, likewise corresponds to the principle of plane-parallel surfaces but longitudinally stepped.

Since there are both concave and convex piezoelectric transducers, the surface of the sound-conducting body need not be plane-parallel. The sound emerging surface toward the medium being metered can therefore also be formed as a curved surface corresponding to a lens. It is solely crucial that the wave emerges perpendicular to the particular point on the surface of the sound-conducting body.

In the following, speed of sound (c), density (ρ), acoustic impedance (Z) and (partly) attenuation (D) are stated for a few substances.

| | c | ρ | Z_{long} | D |
|---|---|---|---|---|
| Substance | (m/s) | (g/cm³ ) | (mPas/m) | (dB/cm) |
| Glassy carbon | 4575 | 1.5 | 7.0 | — |
| Quartz glass | 5530 | 2.2 | 12.1 | — |
| Glass ceramic | 5714 | 2.6 | 15.0 | — |
| Piezoceramic (transducer) | 4330 | 7.3 | 31.1 | — |
| Refined steel (meter pipe) | 5790 | 7.9 | 45.7 | — |
| Polypropylene (sealing | 2660 | 0.89 | 2.36 | 5-18 |
| material)¹⁾ | | | | |
| Water (25° C.) | 1496 | 0.998 | 1.494 | −0.2 |
| Printing ink (filled <50%) | 1750 | 1.4 | 2.5 | >−25 |
| Castor oil | 1500 | 0.942 | 1.4 | −100 |
| Silicone oil | 1352 | 1.11 | 1.5 | −82 |
| Air (0° C.) | 330 | 1.293 · 10⁻³ | 0.4286 | — |
| Nitrogen (0° C.) | 334 | 1.251 · 10⁻³ | — | |

¹⁾For sealing sound-conducting body from interior pressure. Silicone O-rings have D>30 in contrast.

The sound-conducting body is made according to the invention of a material having an acoustic impedance no more than fifteen times, preferably no more than ten times, the acoustic impedance of the liquid or other medium flowing through the meter pipe. This ensures high energy input and therefore high power of the inventive apparatus.

However, the material of the sound-conducting body must also have a high elastic modulus of at least 10 GPa, preferably at least 20 GPa.

An especially suitable material for the sound-conducting body has proved to be glassy carbon. Glassy carbon has an acoustic impedance of about 7 mPas/m, i.e. if the medium flowing through the meter pipe, e.g. water, has an acoustic impedance of 1.5 mPas/m the acoustic impedance of glassy carbon is only about five times higher. In addition, glassy carbon has a high elastic modulus of 35 GPa.

Glassy carbon is a form of carbon with a glasslike breaking pattern (cf. Z. Werkstofftech. 15, 331-338 (1984)).

One can optionally also use e.g. quartz glass according to the invention, or glass ceramic.

In order to reduce the high energy loss occurring at the transition of sound between transmitting transducer and medium and leading to a considerable reduction of the useful signal, two measures are proposed according to the invention: firstly, a boundary surface between sound-conducting body and medium extending perpendicular to the beam and, secondly, the selection of a substance for the sound-conducting body which has a low acoustic impedance differing as little as possible from the medium being metered. In addition, the substance must have a high elastic modulus since, as the inventor knows from experience, plastics for example lead to especially poor useful signals despite their low acoustic impedance.

Compared to plastics, glass ceramic and quartz glass have both a high elastic modulus and a relatively low acoustic impedance. In order to check his theory the inventor therefore first performed tests with a sound-conducting body made of glass ceramic and quartz glass. However, the useful signal was no better than with a sound-conducting body made of steel. Only with the use of a sound-conducting body made of glassy carbon was an about tenfold increase in power over glass ceramic and quartz glass achieved. This is surprising since glassy carbon, glass ceramic and quartz glass come close in their acoustic impedance and elastic modulus. Presumably, it has to do with the surface structure of the sound-conducting bodies on the boundary surface with the flowing medium. As the inventor's microscopic studies have shown, glassy carbon has a surface structure consisting of plane-parallel plates. In contrast, glass ceramic has cracks going deep into the interior over the total surface, causing the ultrasound to be scattered because the dimensions of the cracks are in the order of magnitude of the wavelength.

Glassy carbon, however, has electroconductive properties. Accordingly it may be necessary when using glassy carbon as a sound-conducting body to mount a thin electric insulator, e.g. made of plastic, for example acrylic plastic, or ceramic or glass, between the sound-conducting body and the transducer, or to “ground” the sound-conducting body. Then the fluid is also at “ground potential”.

In contrast, if the medium water has an acoustic impedance of 1.5 mPas/m, steel for example is unsuitable as a sound-conducting body from the point of view of energy balance and retaining physically homogeneous sound pressure waves, as is aluminum oxide ceramic with an acoustic impedance of 32 mPas/m.

The inventive apparatus considerably reduces the energy losses and losses through transformation into other modes of soundwaves (longitudinal into transversal), which otherwise occur in ultrasonic flow measurement.

This makes it possible to meter fluids hitherto inaccessible to ultrasonic flow measurement, in particular highly attenuating, highly viscous, compressible liquids, and suspensions or dispersions with a high particle content of e.g. 50 wt % and more. The inventive apparatus can thus be used for example in the paper industry for flow measurement of liquids for precoating or main coating, or for flow measurement of lacquers and coating agents and at the same time for detecting particles producing defects in the surface.

With usual, i.e. not highly attenuating, fluids the sound path can be shorter with the inventive apparatus because of its high sensitivity, and thus the meter pipe formed with a smaller diameter. This permits the measuring apparatus to be miniaturized.

The inventive apparatus is therefore preferably formed as a measuring head substantially the size of a cigarette box with a through bore to which one or the other end of the meter pipe is connected. The electronics of the measuring transducer is located close beside it.

The measuring head can thus consist of a measuring head body e.g. made of plastic, for example a fluoropolymer such as PVDF, or of refined steel. The through bore can be internally threaded at each end for the meter pipe to be screwed in.

The invention will be explained below in more detail by way of example with reference to the drawing, in which:

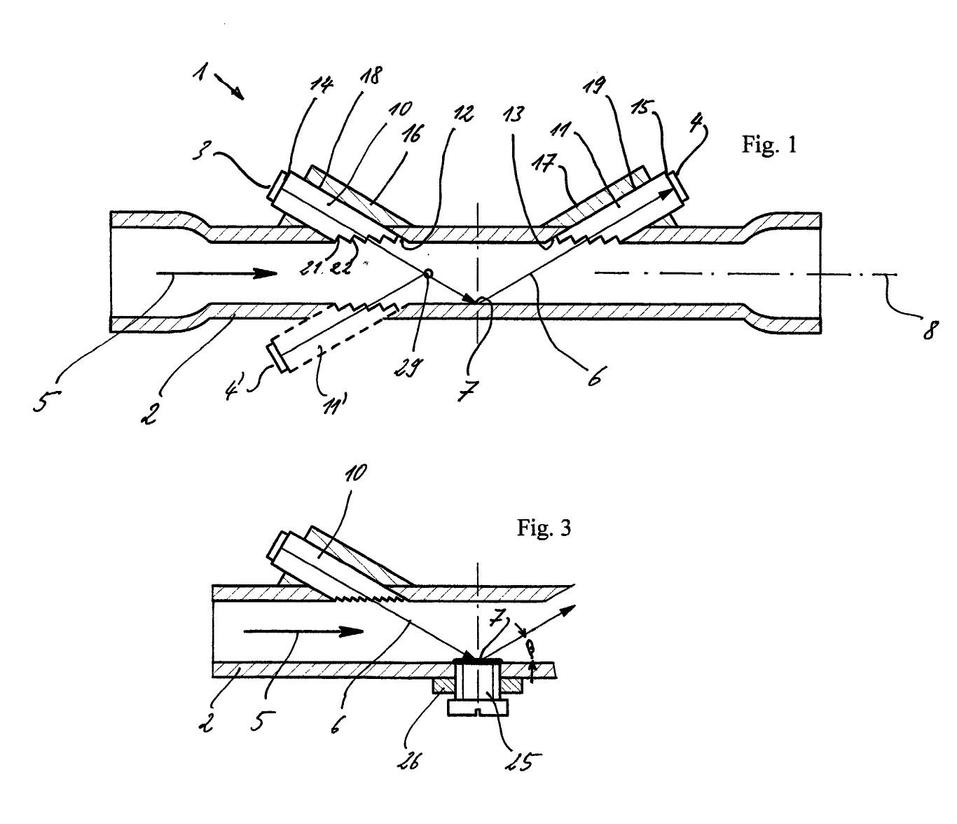

FIG. 1 shows a longitudinal section through a measuring head;

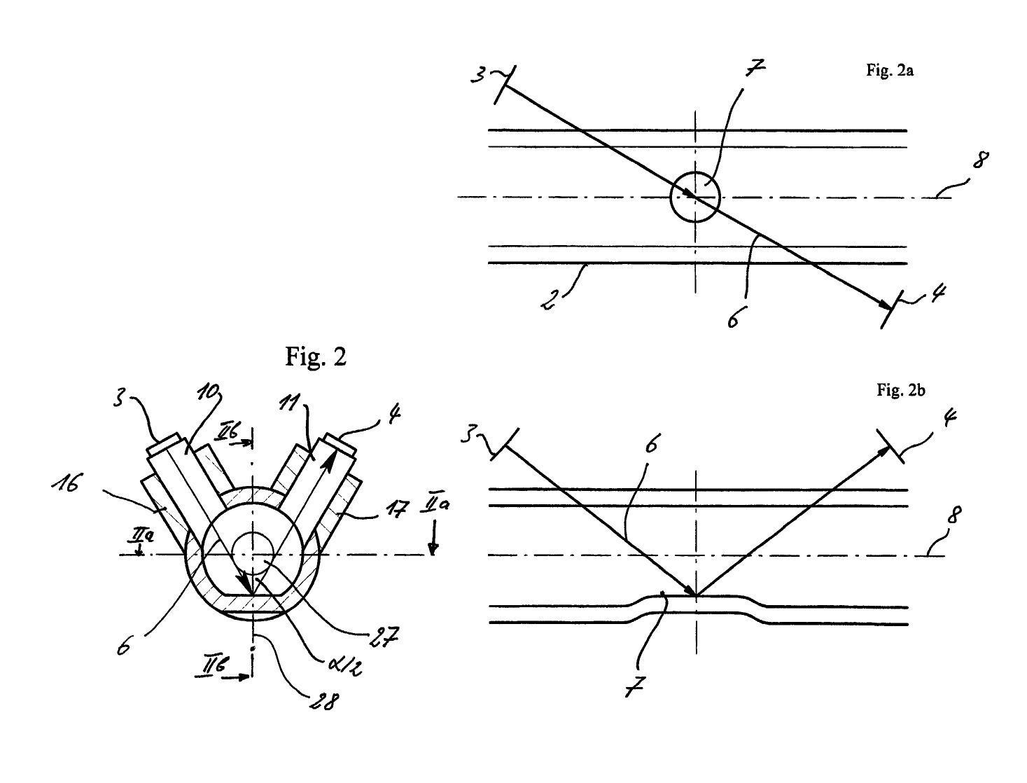

FIG. 2 shows a schematic view of the measuring head from the front according to arrows II-II in FIG. 1, but with angularly offset transducers and in an enlarged view;

FIGS. 2a and 2b show longitudinal sections through the meter pipe on the flattened reflecting surface along line IIa-IIa (i.e. seen from above) and IIb-IIb (seen from the side) in FIG. 2;

FIG. 3 shows a variant of the reflecting surface on the inside wall of the meter pipe, which is radially adjustable before measurement to the prevailing flow velocity of the measurement;

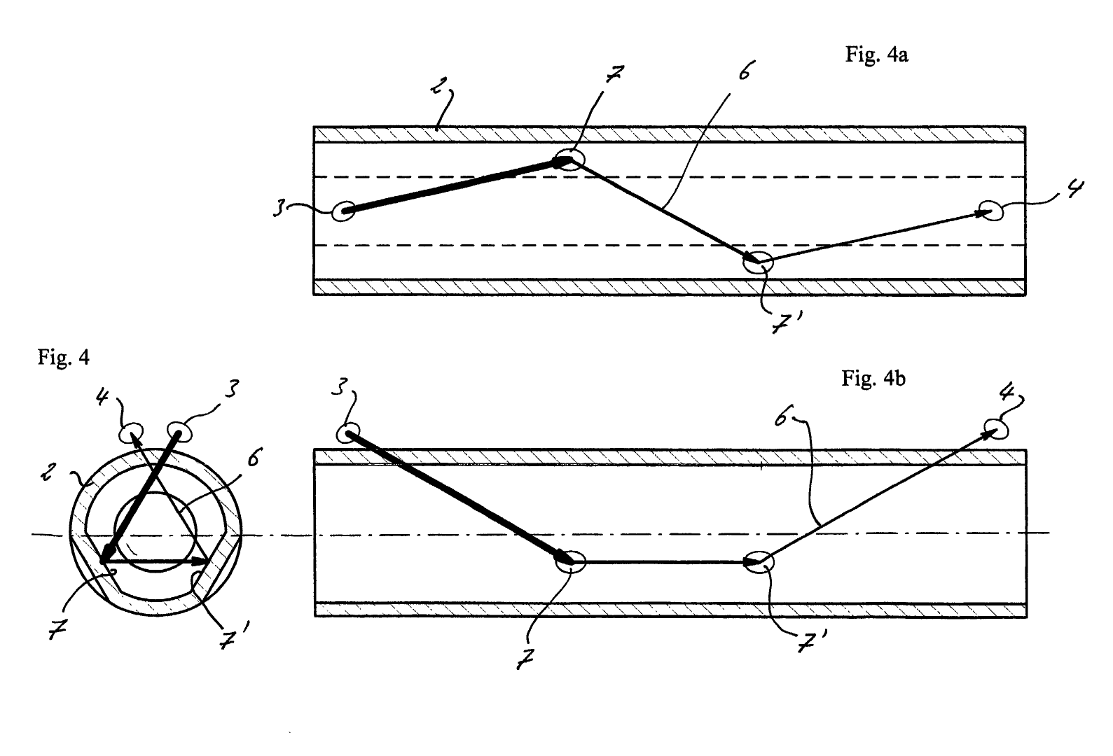

FIG. 4 shows a cross section through the meter pipe according to another embodiment; and

FIGS. 4a and 4b show longitudinal sections (seen from the front and from the side) through the meter pipe according to FIG. 4.

Measuring head 1 according to FIG. 1 is designed for ultrasonic propagation measurement. Meter pipe 2 is thus provided with ultrasonic transmitting transducer 3 and ultrasonic receiving transducer 4. Transducers 3, 4 are directed toward each other, i.e. transmitting transducer 3 is directed in the flow direction of the fluid according to arrow 5 while receiving transducer 4 is directed against flow direction 5.

Further, transducers 3, 4 are disposed a distance apart such that beam 6 reflected on reflecting surface 7 on the inside wall of the meter pipe has a V-shaped path between transmitting transducer 3 and receiving transducer 4.

It is evident that the beam running obliquely to longitudinal axis 8 of the meter pipe can also be reflected on the inside wall of the meter pipe twice or even more frequently, having e.g. a W-shaped or Z-shaped path in case of double reflection, or a VW-shaped path.

Transducers 3, 4 formed as wafer-shaped piezoelectric elements are disposed on the outer faces of pin-shaped sound-conducting bodies 10, 11 made of a material with an acoustic impedance no more than fifteen times the acoustic impedance of the fluid flowing in meter pipe 2. Preferably, sound-conducting bodies 10, 11 are made of glassy carbon.

For beam 6 to pass from transmitting transducer 3 through sound-conducting body 10 into the fluid in meter pipe 2 and from the fluid in meter pipe 2 through sound-conducting body 11 into receiving transducer 4, meter pipe 2 is provided with window-shaped recesses 12, 13 at the inner ends of sound-conducting bodies 10, 11.

Insulating layers 14, 15 made e.g. of acrylic, ceramic or the like are provided between transducers or piezoelectric wafers 3, 4, if necessary, in order to electrically insulate sound-conducting bodies 10, 11 from piezoelectric wafers 3, 4.

For receiving sound-conducting bodies 10, 11 tabs or compact receiving bodies 16, 17 are fastened to the meter pipe, each provided with a bore in which sound-conducting body 10, 11 is disposed. To seal meter pipe 2 outwardly, sound-conducting bodies 10, 11 are e.g. glued, pressed or sintered into the bores by O-rings or similar sealants 18, 19, e.g. by fluorocarbon or hydrofluorocarbon polymers such as polytetrafluoroethylene.

Meter pipe 1 can be made for example of steel, glass or glassy carbon.

In order to prevent sound refraction according to Snell (and other spurious effects) on the boundary surfaces between sound-conducting bodies 10, 11 and the fluid in meter pipe 2, beam 6 passes perpendicularly through said boundary surfaces. For this purpose sound-conducting bodies 10, 11 can have as their boundary surface with the fluid a face perpendicular to their longitudinal axis, i.e. parallel to piezoelectric element 3, 4. However, this forms a dead volume between said boundary surface, the bore in receiving body 16, 17 and meter pipe 2. Gas bubbles can collect in said dead volume and lead to a temporary weakening or interruption of beam 6 and thus to inoperability of the apparatus.

In order to prevent this, the boundary surface between sound-conducting body 10, 11 and the fluid in meter pipe 1 is provided according to FIG. 1 with sound transmission surfaces 21, 22, . . . disposed in steps and extending perpendicular to beam 6, the edges of the steps being flush with the inside wall of meter pipe 2.

Meter pipe 2 preferably has a round or oval or in particular circular diameter. Compared to meter pipes with a square or prismatic cross section, a round cross section has the advantage that there is no unequal reduction of flow velocity in the corners. Compared to a prismatic cross section this firstly improves the flow profile ratio and secondly prevents deposits in corners. To minimize measuring error it is particularly important that measuring is done in the area of constant flow velocity, independently of the varying level of flow velocity.

Reflecting surface 7 plane-parallel to longitudinal axis 8 of meter pipe 2 can be formed by a flattened place in meter pipe 2 (cf. FIGS. 2, 2a, 2b). That is, if the meter pipe is made of steel one can introduce an anvil body with a plane working surface into the pipe for example and flatten the pipe at this place with a pressure ram from outside. It suffices if this place has a size of a few square millimeters. A further advantage is that fewer parasitic soundwaves occur.

As shown in FIG. 3, however, reflecting surface 7 can also be formed by the face of adjusting screw 25 screwed fluid-tight into socket 26 on meter pipe 2. Reflecting surface 7 can thus be adjusted such that beam 6 is radiated from transmitting transducer 3 to receiving transducer 4 with optimum energy. In particular at higher flow velocities one can thus readjust reflecting surface 7 to counteract the effect of the fast-flowing fluid “blowing away” beam 6, so to speak. The radially adjustable reflecting surface can be adjusted before measurement to the prevailing flow velocity or during measurement.

The radial position of reflecting surface 7 of adjusting screw 25 with respect to longitudinal axis 8 of the meter pipe influences angle of reflection β and thus the centric arrival of beam 6 in receiver 4. At very great flow velocities beam 6 is blown away. The consequence is that the amplitude in the receiver is small and might approach zero. This is remedied by radial adjustment in accordance with flow velocity.

A change of flow velocity between laminar and turbulent flow is to be observed in particular in the inner cross-sectional area of meter pipe 2, i.e. within cross-sectional area 27 around the center of the meter pipe, i.e. between longitudinal axis 8 of the meter pipe and approximately radius r/3 of meter pipe 2. At r>0.67 this is no longer the case.

As shown by FIG. 2, beam 6 therefore does not run through longitudinal axis 8 of the meter pipe and runs outside inner cross-sectional area 27 of meter pipe 2, but preferably at r=0.6 to 0.8 due to the diameter of the beam.

For this purpose transducers 3, 4 are offset from each other by angle α to longitudinal axis 8 of the meter pipe. Beam 6 thus hits reflecting surface 7 at an angle (α/2) to longitudinal center plane 28 of the pipe perpendicular to reflecting surface 7 (FIG. 2). This angle is of course not the same angle as in FIGS. 2a and b.

If the inventive apparatus is designed for measuring a fluid stream by the ultrasonic Doppler principle, further receiving transducer 4′ on sound-conducting body 11′ is provided, as shown by the dashed lines in FIG. 1, namely in the same cross-sectional area of meter pipe 1 where transmitting transducer 3 is disposed, whereby receiving transducer 4′ and transmitting transducer 3 are both aligned in flow direction 5. If there is reflector particle 29, reflected radiation 6′ is received by receiving transducer 4′, as shown by dashed lines in FIG. 1. This received signal is about 500 to 1000 times stronger than in old constructions.

In the embodiment according to FIGS. 4, 4a and 4b, beam 6 has a spiral-shaped path outside the inner area of the pipe. For this purpose two (or more) accordingly disposed reflecting surfaces 7, 7′ in the form of flattened pipe wall areas are provided onto which transmitting transducer 3 and receiving transducer 4 are accordingly aligned.

1. A flow measuring apparatus with a meter pipe through which the medium being metered flows, at least two ultrasonic transducers being disposed on said pipe for transmitting and receiving a beam running obliquely to the longitudinal axis of the pipe, the pipe wall being provided with recesses for the beam to pass through from the transmitting transducer into the medium and from the medium to the receiving transducer, characterized in that sound-conducting bodies (10, 11, 11′) are disposed between the transducers (3, 4, 4′) and the medium, the beam (6) passing perpendicularly through the boundary surfaces of said bodies with the medium and said bodies having an acoustic impedance no more than fifteen times the acoustic impedance of the medium.

2. An apparatus according to claim 1, characterized in that at least one of the sound-conducting bodies (10, 11, 11′) is made of glassy carbon.

3. An apparatus according to claim 2, characterized in that electric insulators (14, 15) are provided between the sound-conducting bodies (10, 11) and the transducers (3, 4).

4. An apparatus according to claim 1, characterized in that for the beam (6) to pass through perpendicularly the boundary surface is provided with sound transmission surfaces (21, 22, 23 . . . ) disposed in steps and extending perpendicular to the beam (6), the edges of the steps lying on a straight line flush with the inside wall of the meter pipe.

5. An apparatus according to any of the above claims, characterized in that the transducers (3, 4) are aligned toward each other and disposed a distance apart such that the beam (6) is reflected on the inside wall of the meter pipe on at least one reflecting surface (7, 7′) plane-parallel to the longitudinal axis (8) of the meter pipe.

6. An apparatus according to claim 5, characterized in that the meter pipe (2) has a round cross section outside the reflecting surfaces (7, 7′).

7. An apparatus according to claims 5 and 6, characterized in that the reflecting surface or surfaces (7, 7′) are formed by a flattened place on the meter pipe (2).

8. An apparatus according to claim 5 or 6, characterized in that the at least one reflecting surface (7) is formed by the face of an adjusting screw (25).

9. An apparatus according to any of claims 5 to 8, characterized in that the beam (6) hits the reflecting surface (7) at an angle (α/2) to the longitudinal center plane (28) of the meter pipe perpendicular to the reflecting surface (7).

10. An apparatus according to claim 9, characterized in that the angle (α/2) assumed by the beam (6) to the longitudinal center plane (28) of the meter pipe perpendicular to the reflecting surface (7, 7′, 7″) is dimensioned such that the beam (6) runs at a distance from the longitudinal axis (8) of the meter pipe which is greater than half the radius (r/2) of the meter pipe (2).
